(19) United States
(12) Patent Application Publication
(10) Pub. No.: US 2026/0217912 A1
(43) Pub. Date: Jul. 30, 2026

(54) ALKOXYLATION PROCESSES USING MONOCATIONIC AND DICATIONIC CYCLOPENTADIENYL PHOSPHORUS CATALYSTS

(71) Applicants: DOW GLOBAL TECHNOLOGIES LLC, Midland, MI (US); ROHM AND HAAS COMPANY, Collegeville, PA (US)

(72) Inventors: Peter J. WALLER, Midland, MI (US); Varinia BERNALES, Midland, MI (US); David S. LAITAR, Midland, MI (US); Clark H. CUMMINS, Midland, MI (US); Matthew E. BELOWICH, Collegeville, PA (US)

(21) Appl. No.: 19/140,991

(22) PCT Filed: Dec. 11, 2023
(86) PCT No.: PCT/US2023/083367

§ 371 Date: Jun. 18, 2025

Related U.S. Application Data
(60) Provisional application No. 63/433,549, filed on Dec. 19, 2022.

(51) Int. Cl. C08G 65/26

(52) U.S. Cl. CPC C08G 65/2609; C08G 65/2675; C08G 2650/58

(57) ABSTRACT

Alkoxylations are performed by reacting a cyclic oxide with a starter compound in the presence of certain cyclopentadienyl phosphorus catalysts. The cyclopentadienyl phosphorus catalysts are highly active and effective in such small quantities that it is often unnecessary to remove catalyst residues from the product. The cyclopentadienyl phosphorus catalysts are very effective in alkoxylating even low molecular weight starter compounds such as glycerol and sorbitol.

This invention relates to an alkoxylation process in which a cyclic oxide is added onto a starter compound to produce an ether or polyether.

Polyethers are produced globally in large quantities. Polyether polyols, for example, are an important raw material for producing polyurethanes. Among other things, they are used to make high resiliency, molded, or rigid foams. Polyether monols are used, for example, as surfactants and industrial solvents, among other uses. Carbonate- and ester-modified alkylene oxide polymers also find uses in these and other applications.

Polyether monols and polyols are produced via alkoxylation of a starter compound, in which an active site on the starter reacts with a cyclic oxide in a ring-opening reaction. A terminal hydroxyl group is produced, which in turn can function as an active site for a subsequent alkoxylation step, thereby producing a polyether chain. The active site of the starter compound is a group containing an active hydrogen, such as a hydroxyl or thiol group. The main functions of the starter compound are to provide molecular weight control and to establish the number of hydroxyl groups the alkoxylated product will have.

A catalyst is needed to obtain economical polymerization rates. The most commonly used catalysts are alkali metal hydroxides such as potassium hydroxide and the so-called double metal cyanide (DMC) catalyst complexes, of which zinc hexacyanocobaltate catalyst complexes are the most commercially important type.

Alkali metal hydroxides provide the benefits of low catalyst costs and acceptable alkoxylation rates. They are versatile in that they effectively polymerize many alkylene oxides. Nonetheless, alkali metal hydroxides have well-known drawbacks. The alkoxylated product must be neutralized, and catalyst residues scrupulously removed. These finishing steps add greatly to both capital and operating costs and produce additional waste streams that must be cleaned up and/or disposed of.

DMC catalysts provide rapid polymerization rates compared to alkali metal catalysts, even when used at very low catalyst concentrations. An important advantage of DMC catalysts over alkali metal hydroxides is no neutralization step is needed. The catalyst residues often can be left in the product, unlike the case when alkali metal hydroxides are used as the polymerization catalyst. This can result in significantly lower production costs. Nonetheless, the DMC catalysts have significant disadvantages as well. They tend to perform poorly in the presence of high concentrations of hydroxyl groups, and especially in the presence of low molecular weight starter compounds like glycerin or sorbitol that have hydroxyl groups in the 1,2- or 1,3-positions with respect to each other. Under these conditions, the catalysts are difficult to activate, perform sluggishly and often deactivate before the polymerization is completed. This represents a significant limitation on the widespread adoption of DMC catalysts. It is often necessary to produce the polyether in two or more discrete steps, in which the early stages of the polymerization are conducted in the presence of an alkali metal catalyst and, after cleaning up the resulting intermediate product, the remainder of the polymerization is performed using the DMC catalyst. This approach requires the intermediate to be neutralized and purified (because the DMC catalyst is deactivated by strong bases), thus re-introducing costs which the DMC-catalyzed polymerization is intended to avoid.

Certain Lewis acids have been evaluated as alkylene oxide polymerization catalysts. The Lewis acids require essentially no activation time, but deactivate rapidly and therefore cannot produce high molecular weight polymers or high conversions of alkylene oxide to polymer. Another problem with many Lewis acid catalysts is that they deactivate at higher operating temperatures. This disqualifies them for use with certain starters that are solids, viscous, or otherwise poorly miscible with the cyclic oxide, because in those cases high operating temperatures are needed to melt the starter, reduce its viscosity or promote mixing with the cyclic oxide.

Various Lewis acidic phosphorus compounds have been described in the literature. See, for example, Science 341 1374 (2013), Dalton Trans. 2018, 47, 11411, Chem. Eur. J. 2015, 21, 6491-6500, Dalton Trans. 2016, 45, 5568, Angew. Chem. Int. Ed. 2014, 53, 6538-6541, Chem. Sci. 2015, 6, 2016 and Chem. Commun., 2018, 54, 662-665. They have been described for use as catalysts in various reactions such as olefin isomerization, hydrosilylation, dehydrocoupling, hydrodefluorination, hydrogenation and Friedel-Crafts reactions. Angew. Chem. Int. Ed. 2014, 53, 6538-6541 describes the use of a phosphonium catalyst to polymerize tetrahydrofuran in the absence of starter to produce an 86,000 molecular weight polymer with high polydispersity.

This invention is an alkoxylation process, comprising (step I) forming a reaction mixture comprising a) a starter compound having at least one hydroxyl or thiol group; b) at least one cyclic oxide and c) a catalytically effective amount of a phosphorus catalyst having either of the structures: (Cp*PX)⁺ₙ Aⁿ⁻ or (Cp*P)²⁺ (Aⁿ⁻)_{2/n} where Cp* designates an optionally substituted cyclopentadienyl ligand, X represents halogen, hydroxyl, unsubstituted or inertly substituted alkyl, unsubstituted or inertly substituted alkoxy, or unsubstituted or inertly substituted aryloxy, A represents a weakly coordinating anion and n is the absolute value of the valence of A, and (step II) reacting the cyclic oxide with the starter compound in the presence of the cationic phosphorus catalyst to form an alkoxylated product.

An advantage of the process of the invention is very high alkoxylation rates are obtained using very small amounts of the cationic phosphorus catalysts, and for that reason, catalyst residues can be left in the product (unlike potassium hydroxide), thereby reducing or even eliminating catalyst deactivation and removal steps. Unlike DMC catalysts, these compounds are highly effective at polymerizing oxiranes onto very low molecular weight initiators and are also effective ethylene oxide polymerization catalysts. The cationic phosphorus catalysts described herein are particularly useful for alkoxylating low molecular weight starters with 1 to 12 oxyalkylene units per active site.

The Cp* ligand has the structure

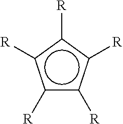

wherein each R is independently hydrogen or an inert substituent. Inert substituents do not react with the starter or cyclic oxide under the conditions of the alkoxylation reaction and include, for example, alkyl (linear, branched and/or cyclic), aryl, alkyl-substituted aryl, aryl-substituted alkyl, halogen (especially F, Cl, Br), alkoxyl, oxyaryl, and the like. For example, the R groups may be selected from hydrogen, F, Cl, C₁₋₄ alkyl, phenyl, methoxy or ethoxy. In some embodiments, all R groups are the same. Any two R groups, particularly any two adjacent R groups, may together form a cyclic structure at includes the carbon atoms of the cyclopentadienyl ring to which the R groups are bonded. Such cyclic structures may be aliphatic or aromatic. In specific embodiments, Cp* is cyclopentadienyl, pentafluorocyclopentadienyl, pentachlorocyclopentadienyl, pentamethylcyclopentadienyl, pentaethylcyclodienyl or pentaphenylcyclopentadienyl, indenyl or fluorenyl.

(Cp*PX)⁺ₙ cations are monocationic and may exist in an η²-Cp* configuration. (Cp*P)²⁺ cations are dicationic and may exist in an η⁵-Cp* configuration. Dicationic phosphorus catalysts corresponding to the structure (Cp*P)²⁺ (Aⁿ⁻)_{2/n} may in addition have one or more solvent ligands coordinated to the structure.

X, when present, is one or more of F, Cl, Br, I, unsubstituted or inertly substituted C¹⁻¹² alkyl, unsubstituted or inertly substituted alkoxy, unsubstituted or inertly substituted aryl or unsubstituted or inertly substituted aryloxy. Inert substituents for the X group include, for example, alkyl (linear, branched and/or cyclic), aryl, alkyl-substituted aryl, aryl-substituted alkyl, halogen (especially F, Cl, Br), alkoxyl, oxyaryl, ether (—O—), ester (—O—C(O)—), carbonate (—O—C(O)—O))—, halogen (especially F, Cl, Br and/or I), sulfide (—S—), polysulfide (—S_{z}—, where z>1), amino, silyl and the like. X, when present is preferably F, Cl, Br, methoxy, ethoxy, methyl, ethyl, phenoxy, phenyl or —CF₃. An X group preferably does not contain active sites such as —OH, —NH, —SH or —COOH where alkoxylation can take place, and preferably does not contain cyclic oxide structures.

The anion A is a weakly coordinating anion that has a valence of n-, n being 1 or 2. Weakly coordinating anions are those whose coordination to the associated cation is weaker than that of the surrounding solvent molecules. Coordination strength of an anion is conveniently determined by forming a tri-n-octylammonium salt of the anion, dissolving the salt in carbon tetrachloride, and measuring the N—H stretching frequency by infrared spectroscopy, using a method as described, for example, in J. Am. Chem Soc. 2006, 128, 8500-8508. An N—H stretching frequency of 3000 cm-1 or greater, especially 3050 cm-1 or greater, is indicative of a weakly coordinating anion.

Examples of weakly coordinating anions include tetrakis(perfluorophenyl)borate, tetrakis[3,5-bis(trifluoromethyl)phenyl]borate, trifluoromethanesulfonate (triflate), Al[OC(CF₃)₃]₄⁻, HCB₁₁Me₅F₆⁻, B₁₂F₁₂²⁻, HCB₁₁H₅F₆⁻, B(OTeF₅)₄⁻, B(OTeF₅)₆⁻, Sb(OTeF₅)₄⁻, Sb(OTeF₅)₆⁻, Al[OC(CF₃)₃]₄⁻, Al[OCH(CF₃)₂]₄⁻ and Al[OC(CH₃)(CF₃)₂]₄⁻.

Specific examples of phosphorus catalysts include: Cp*P²⁺ (A⁻)₂, Cp*PF⁺A⁻, Cp*PCl⁺A⁻, Cp*PBr⁺A⁻, Cp*POMe⁺A⁻, Cp*POEt⁺A⁻ and Cp*POPh⁺A⁻, where Cp* is as before, especially unsubstituted cyclopentadienyl, pentaflurocyclopentadienyl, pentachlorocyclopentadienyl, pentamethylcyclopentadienyl, pentethylcyclopentadienyl, pentaphenylcyclopentadienyl, indenyl or fluorenyl, OMe represents methoxy, OEt represents ethoxy, OPh represents phenoxy and A⁻ in each case is monovalent. Analogous compounds in which A represents a divalent weakly coordinating anion are also useful. A is preferably a monovalent anion such as most tetrakis[perfluorophenyl]borate, tetrakis[3,5-bis(trifluoromethyl)phenyl]borate and trifluoromethanesulfonate (triflate).

Especially preferred phosphorus catalysts are the tetrakis[perfluorophenyl]borate salts of Cp*P²⁺, Cp*PF⁺¹ and Cp*PCl⁺¹, where Cp* is as before and preferably is cyclopentadienyl, pentafluorocyclopentadienyl, pentachlorocyclopentadienyl, pentamethylcyclopentadienyl, pentaethylcyclodienyl or pentaphenylcyclopentadienyl, indenyl or fluorenyl.

Methods useful for preparing the phosphorus catalyst are generally described, for example, in Chem. 2018, 2699-2708.

The alkoxylation is performed in the presence of one or more starter compounds. The starter compound has one or more functional groups capable of being alkoxylated. The starter may contain any larger number of such functional groups. In some embodiments, the starter has one or more hydroxyl groups and no primary amino or secondary amino groups. The functional groups may be, for example, primary, secondary or tertiary hydroxyl, or thiol. A preferred starter contains 1 or more such functional groups, preferably 2 or more of such functional groups, and may contain as many as 12 or more of such functional groups.

In certain embodiments, the functional groups are all hydroxyl groups. In some embodiments, the starter compound will have 2 to 8, 2 to 6, 2 to 4 or 2 to 3 hydroxyl groups.

The starter compound has an equivalent weight per functional group less than that of the polyether product. It may have an equivalent weight of 9 (in the case of water) to 6000 g/equivalent or more. The invention has particular advantages when the starter compound is a low equivalent weight alcohol or polyol (up to 500, up to 250, up to 125 and especially up to 80 g/equivalent, for example) and for that reason prior to alkoxylation has a high concentration of hydroxyl groups. Equivalent weight of an alcohol or polyol is conveniently determined using titration methods such as ASTM 4274-21, which yield a hydroxyl number in mg KOH/gram of polyol that can be converted to equivalent weight using the relation equivalent weight=56, 100÷hydroxyl number.

Among the suitable starters are vinyl alcohol, propenyl alcohol, allyl alcohol, acrylic acid, hydroxyethyl acrylate, hydroxyethyl methacrylate, a C₁₋₅₀ alkanol, especially a C₁₋₁₂ alkanol, phenol, cyclohexanol, an alkylphenol, water (considered for purposes of this invention as having two hydroxyl groups), ethylene glycol, diethylene glycol, triethylene glycol, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, sorbitol, sucrose, xylitol, mannitol, maltitol, sucralose, phenol, polyphenolic starters such as bisphenol-A or 1,1,1-tris(hydroxyphenyl) ethane, and the like. Any two or more of the foregoing starters may be used together if desired.

The cyclic oxide is characterized in having a least one 3-, 4- or 5-member ring structure that contains an oxygen atom in the ring structure. Especially preferred cyclic oxides are oxiranes that have a three-member, oxygen-containing ring. The cyclic oxide(s) may be, for example, ethylene oxide, 1,2-propylene oxide (generally referred to herein as “propylene oxide”), oxetane, 1,2-butene oxide, 2-methyl-1,2-butene oxide, 2,3-butene oxide, tetrahydrofuran, epichlorohydrin, hexene oxide, octene oxide, styrene oxide, divinylbenzene dioxide, a glycidyl ether such as bisphenol-A diglycidyl ether, epichlorohydrin or other polymerizable oxirane. In some embodiments, the alkylene oxide is 1,2-propylene oxide, ethylene oxide, or a mixture thereof, including, for example, a mixture of at least 50% (preferably at least 80%) by weight propylene oxide and correspondingly up to 50% (preferably up to 20%) by weight ethylene oxide. In some embodiments, two or more alkylene oxides are polymerized simultaneously (to form random copolymers), and or the composition of the alkylene oxide is changed one or more times, or even continuously, throughout the course of the polymerization to form block and/or random/block copolymers.

The alkoxylation is performed by combining the starter and phosphorus catalyst with the cyclic oxide(s) and optionally comonomer and subjecting the resulting reaction mixture to reaction conditions. The catalyst may be added as a solution in a solvent. Such a solvent preferably is inert under the conditions of the alkoxylation reaction. Diethyl ether, dichloromethane and hydrocarbons such as toluene or hexane are useful solvents for the phosphorus catalyst.

The alkoxylation proceeds at a wide range of temperatures from −100° C. to 250° C. or more. In some embodiments, the reaction temperature is at least 80° C., at least 100° C., at least 120° C., at least 130° C. or at least 150° C. The polymerization temperature preferably does not exceed 190° C., and more preferably does not exceed 180° C. An important advantage of the phosphorus catalysts used in the invention is they perform well without premature deactivation at higher temperatures, especially 150° to 200° C. or 150° to 180° C. The higher temperatures promote faster reactions. Additionally, the ability to operate at these higher temperatures permits the process to be used with starters and/or cyclic oxides that have somewhat high melting temperatures (such as sorbitol, xylitol, mannitol, maltitol, sucralose) and/or which are viscous at lower temperatures, or which, like sorbitol and glycerin, have limited solubility in the cyclic oxide at lower temperatures.

The alkoxylation reaction usually is performed at a superatmospheric pressure, but can be performed at atmospheric pressure or even a subatmospheric pressure.

Enough of phosphorus catalyst is used to provide a commercially reasonable alkoxylation rate, but it is generally desirable to use as little thereof as possible consistent with reasonable alkoxylation rates, as this both reduces the cost for the catalyst and can eliminate the need to remove catalyst residues from the product. The amount of phosphorus catalyst may be, for example, sufficient to provide 10 to 10,000 ppm by weight of phosphorus catalyst based on the weight of the starter. In specific embodiments, the amount of phosphorus catalyst may be sufficient to provide at least 25 ppm, at least 50 ppm or at least 100 ppm catalyst on the foregoing basis, and up to 1,000 ppm or up to 500 ppm catalyst, again on the foregoing basis. The weight of the phosphorus catalyst includes the weight of both cation and associated anion.

The alkoxylation reaction can be performed batch-wise, semi-continuously (including with continuous addition of starter as described in U.S. Pat. No. 5,777,177) or continuously.

The alkoxylation reaction can be performed in any type of vessel that is suitable for the pressures and temperatures encountered. The reactor should be equipped with a means of providing and/or removing heat, so the temperature of the reaction mixture can be maintained within the required range. Suitable means include various types of jacketing for thermal fluids, various types of internal or external heaters, and the like. A cook-down step performed on continuously withdrawn product is conveniently conducted in a reactor that prevents significant back-mixing from occurring. Plug flow operation in a pipe or tubular reactor is a preferred manner of performing such a cook-down step.

The crude product obtained in any of the foregoing processes may contain unreacted cyclic oxide, small quantities of the starter compound and low molecular weight alkoxylates thereof, and small quantities of other organic impurities and/or water. Volatile impurities (including unreacted cyclic oxides) should be flashed or stripped from the product. The crude product typically contains catalyst residues. It is typical to leave these residues in the product, but these can be removed if desired. Moisture and volatiles can be removed by stripping the alkoxylated product.

The process of the invention is useful for preparing alkoxylated products that can have hydroxyl equivalent weights from as low as about 85 g/equivalent to as high as about 8,000 or more, in each case greater than that of the starter. Alkoxylated polyols produced in accordance with the invention are useful raw materials for producing polyurethanes and other polymers made by reacting the alkoxylated polyol with a polyisocyanate. These products include a wide variety of cellular and non-cellular materials, which may vary in physical properties from very rigid to highly flexible. Alkoxylated monols produced in accordance with the invention are useful as surfactants or as industrial solvents, among other uses. Alkoxylated polyols and monols can be aminated to produce the corresponding amine-terminated materials, which are in turn useful raw materials for making various materials including polyureas and cured epoxy resins.

In particular embodiments, the starter is a polyol having a hydroxyl equivalent weight of 125 g/equivalent or less, especially 75 g/equivalent or less or even 50 g/equivalent or less, and the alkoxylation is continued to produce an alkoxylated product having 1 to 12, especially 1 to 10, 1 to 5 or 1 to 3 units of polymerized cyclic oxide per hydroxyl group on the starter. The number average molecular weight of the alkoxylated product may be, for example, 100 to 1000 g/mol, 100 to 800 g/mol, 150 to 800 g/mol or 200 to 800 g/mol, in each case greater than the number average molecular weight of the starter. In such particular embodiments, the cyclic oxide is preferably 1,2-propylene oxide, ethylene oxide, 1,2-butylene oxide, 2,3-butylene oxide, epichlorohydrin or a mixture of any two or more thereof, with 1,2-propylene oxide, ethylene oxide or a mixture thereof being particularly preferred. The starter in such embodiments most preferably is one or more of glycerin, trimethylolpropane, trimethylolethane, erythritol, pentaerythritol, sorbitol and sucrose. Such products are useful raw materials for making rigid polyurethane and/or polyisocyanurate polymers, including foams.

In some embodiments the cyclic oxide is polymerized with or in the presence of one or more copolymerizable monomers that are not cyclic oxides. Examples of such copolymerizable monomers include carbonate precursors that copolymerize with an alkylene oxide to produce carbonate linkages in the product. Examples of such carbonate precursors include carbon dioxide, phosgene, linear carbonates and cyclic carbonates. Other copolymerizable monomers include carboxylic acid anhydrides, which copolymerize with cyclic oxides to produce ester linkages in the product.

The following examples are provided to illustrate the invention but are not intended to limit the scope thereof. All parts and percentages are by weight unless otherwise indicated.

### Catalyst Preparation Procedure

Tetrakis(pentafluorophenyl) borate salts of PMCp*PF⁺, PMCp*PCl⁺ and PMCp*P²⁺, where PMCp* in each case is pentamethylcyclopentadienyl, are prepared in the general manner described in Chem. 4, 2699-2708. The PMCp*P²⁺ dication may have one or more toluene ligands coordinated to the structure.

### EXAMPLES 1-4 AND COMPARATIVE SAMPLES A-C

45 grams of starter (monopropylene glycol in Ex. 4 and sorbitol in Ex. 5, glycerol in all other cases) are charged into a semi-batch reactor equipped with stirrer, temperature controls, nitrogen feed and monomer feed lines and a vent. Catalyst is added as a solid. The type and amount of catalyst are as indicated in Table 1. The reactor is purged with nitrogen and heated to the temperature indicated in Table 1 with stirring, then purged again with nitrogen to remove any solvent from the catalyst addition. While maintaining the same temperature, propylene oxide then is fed into the reactor on demand to attempt to maintain a target propylene oxide partial pressure as indicated in Table 1. The target amount of propylene oxide to be added is approximately 103 g; the actual amounts fed are indicated in Table 1. The time required to feed the propylene oxide (run time) is indicated in Table 1. Upon completion of monomer feed, the reaction is digested at 160° C. for 2 hours and then cooled to 50° C. under nitrogen purge. After purging with nitrogen at 50° C. for 10 minutes, the product is collected, and yield is calculated. The product is analyzed for Mn and polydispersity by gel permeation chromatography against polystyrene standards.

The activities of the catalysts are compared by calculating a turnover frequency (TOF) in each instance. TOF reflects the number of propylene oxide molecules converted per catalytic site per unit time, as follows:

$$T O F = \frac{mmol PO consumed}{mmol catalyst \times run time ( hr )} .$$

Higher values indicate greater catalyst activity.

The phosphorus catalysts are as indicated in Table 1.

In Table 1, KOH designates potassium hydroxide and BF₃·OEt₂ designates boron trifluoride diethyl etherate.

TABLE 1

| | | | | PO | | | | | | |
|---|---|---|---|---|---|---|---|---|---|---|
| | | | | partial | | | | | | |
| | | | | pressure, | Run | PO | | | | |
| | | Loading | T, | psi | time | Fed | Yield | TOF | Mₙ, | |
| Ex. | Catalyst | (ppm) | ° C. | (kPa) | (h) | (mL) | (g) | (hr⁻¹) | g/mol | PDI |
| A* | KOH | 4000 | 130 | 30 (207) | 1.6 | 103.8 | 112.3 | 207 | 412 | 1.02 |
| B* | BF₃•Oet₂ | 111 | 100 | 11 (76) | 47.2 | 24.5 | 37.1 | 211 | ND | ND |
| C* | B(C₆F₅)₃ | 667 | 80 | 7 (48) | 1.7 | 103.0 | 114.7 | 14,768 | 407 | 1.10 |
| 1 | PMCp*PCl⁺ | 356 | 160 | 30 (207) | 0.6 | 103.1 | 118.4 | 142,035 | 407 | 1.10 |
| 2 | PMCp*PF⁺ | 500 | 160 | 30 (207) | 0.6 | 102.9 | 114.2 | 97,385 | 411 | 1.10 |
| 3 | PMCp*P⁺ | 500 | 160 | 30 (207) | 0.6 | 103.6 | 114.0 | 169,998 | 414 | 1.10 |
| 4** | PMCp*P⁺ | 500 | 160 | 30 (207) | | | | | 300 | ND |
| 5** | PMCp*P⁺ | 500 | 160 | 30 (207) | 0.96 | 156.2 | 131.3 | 157,524 | 691 | 1.16 |

*Not an example of the invention.
ND—not done.
**Monopropylene glycol is the starter in Example 4, and sorbitol is the starter in Example 5; glycerol is the starter in all other cases.
¹“PMCp*” is the pentamethylcyclopentadienyl ligand. Catalysts used in Ex. 1-5 are all tetrakis(pentafluorophenyl) borate salts of the indicated cation. “PO partial pressure” is the target PO partial pressure in the reactor during the polymerization. The Run time indicates the time required to feed the indicated amount of propylene oxide. “PO Fed” indicates the total amount of propylene oxide fed during the indicated run time. “TOF” is turnover frequency. PDI is the polydispersity index, i.e., weight average molecular weight divided by number average molecular weight. Molecular weights are measured by GPC against polystyrene standards.

As indicated by the data in Table 1, the catalysts of the invention are extremely active compared to the controls. When glycerol in the starter, turnover frequencies range are approximately 470 to 820 times greater than that of KOH, which is the industry workhorse propylene oxide polymerization catalyst. The greater catalytic activity leads to drastically reduced run times, effectively increasing the production capability of the manufacturing equipment proportionally. Molecular weight and polydispersity are similar to those obtained in the KOH-catalyzed run (Comp. A).

1. An alkoxylation process comprising the following steps:
(I) forming a reaction mixture comprising; a) a starter compound having at least one hydroxyl or thiol group, b) at least one cyclic oxide, and c) a catalytically effective amount of a phosphorus catalyst having either of the structures: (Cp*PX)⁺ₙ Aⁿ⁻ or (Cp*P)²⁺(Aⁿ⁻)_{2/n} where Cp* designates an optionally substituted cyclopentadienyl ligand, X represents halogen, hydroxyl, unsubstituted or inertly substituted alkyl, unsubstituted or inertly substituted alkoxy, or unsubstituted or inertly substituted aryloxy, A represents a weakly coordinating anion, and n is the absolute value of the valence of A; and
(II) reacting the cyclic oxide b) with the starter compound a) in the presence of the phosphorus catalyst c) to form an alkoxylated product.

2. The alkoxylation process of claim 1, wherein Cp* is cyclopentadienyl, pentafluorocyclopentadienyl, pentachlorocyclopentadienyl, pentamethylcyclopentadienyl, pentaethylcyclopentadienyl, pentaphenylcyclopentadienyl, indenyl, or fluorenyl.

3. The alkoxylation process of claim 1, wherein the phosphorus catalyst c) has the structure (Cp*P)²⁺(Aⁿ⁻)_{2/n}.

4. The alkoxylation process of claim 1, wherein the phosphorus catalyst c) has the structure (Cp*PX)⁺ₙ Aⁿ⁻.

5. The alkoxylation process of claim 4, wherein X is F, Cl, Br, I, methoxy, ethoxy, methyl, ethyl, phenoxy, phenyl, or —CF₃.

6. The alkoxylation process of claim 5, wherein X is F, Cl, Br, or I.

7. The alkoxylation process of claim 5, wherein X is F or Cl.

8. The alkoxylation process of claim 1, wherein A is selected from the group consisting of tetrakis[perfluorophenyl]borate, tetrakis[3,5-bis(trifluoromethyl)phenyl]borate, trifluoromethanesulfonate, Al[OC(CF₃)₃]₄⁻, HCB₁₁H₅F₆⁻, B(OTeF₅)₄⁻, B(OTeF₅)₆⁻, Sb(OTeF₅)₄⁻, Sb(OTeF₅)₆⁻, Al[OC(CF₃)₃]₄⁻, Al[OCH(CF₃)₂]₄⁻, and Al[OC(CH₃)(CF₃)₂]₄⁻.

9. The alkoxylation process of claim 8, wherein A is tetrakis(perfluorophenyl)borate, tetrakis[3,5-bis(trifluoromethyl)phenyl]borate, or trifluoromethanesulfonate.

10. The alkoxylation process of claim 1, wherein A is selected from the group consisting of B₁₂F₁₂²⁻, B₁₂Cl₁₂²⁻, and B₁₂Br₁₂²⁻.

11. The alkoxylation process of claim 1, wherein the starter compound a) has a hydroxyl equivalent weight of up to 80 g/equivalent.

12. The alkoxylation process of claim 1, wherein the starter compound a) has one or more hydroxyl groups and no primary amino and secondary amino groups.

13. The alkoxylation process of claim 1, wherein the cyclic oxide b) comprises an oxirane.

14. The alkoxylation process of claim 13, wherein the cyclic oxide b) comprises one or more of ethylene oxide, 1,2-propylene oxide, 1,2-butene oxide, and 2,3-butene oxide.

15. The alkoxylation process of claim 1, wherein step (II) is performed at a temperature of from 150 to 200° C.
